(19) United States
(12) Patent Application Publication
(10) Pub. No.: US 2026/0057034 A1
(43) Pub. Date: Feb. 26, 2026

(54) DYNAMIC TESTING OF TECHNICAL SYSTEMS FOR COMPLETE DESCRIBABILITY, STARTING FROM A PREDETERMINED OPERATION SITUATION

(71) Applicant: Robert Bosch GmbH, Stuttgart (DE)

(72) Inventors: Peter Bakucz, Klosterlechfeld (DE); Martin Hruschka, Abstatt-Happenbach (DE)

(21) Appl. No.: 18/855,909

(22) PCT Filed: Jun. 5, 2023
(86) PCT No.: PCT/EP2023/064932

§ 371 Date: Oct. 10, 2024

(30) Foreign Application Priority Data
Jun. 8, 2022 (DE) 10 2022 205 836.4

(51) Int. Cl. G06F 17/13

(52) U.S. Cl. CPC G06F 17/13

(57) ABSTRACT

A method for testing to what extent the dynamics of a technical system starting from a predetermined operation situation are completely described through the acquisition of the state of the technical system with multiple sensors in combination with at least one differential equation. The method includes establishing a dynamics function describing the predetermined operation situation and dynamics of the technical system; forming the at least one differential equation from the dynamics function; ascertaining initial conditions, boundary conditions and/or regional conditions based on the predetermined operation situation for solving the at least one differential equation; testing whether the differential equation is analytically solvable; and in response to a positive determination, determining that the acquisition with the sensors and the at least one differential equation completely describe the dynamics of the system.

### FIELD

The present invention relates to the monitoring of technical systems whose state is acquired with one or more sensors and whose dynamics are modeled with a differential equation using one or more variables.

### BACKGROUND INFORMATION

For the control of many technical systems, it is important to ascertain a forecast for the dynamics of the system in the future from the observation of the system by sensors over a past period of time. This forecast is ascertained on the basis of a model from measurement data acquired by sensors and serves as the basis for the further control of the corresponding system. For example, on the basis of sensor data, a vehicle can predict its future driving dynamics at least for some time units or time steps in advance, and a control system can intervene, if necessary, in order to alter these driving dynamics in the desired manner. An example of such a control system is the electronic stability program, ESP, according to European Patent No. EP 0 339 056 B1.

In order for such control systems to function properly, it is necessary for the corresponding technical system to actually behave as the model used predicts on the basis of the sensor data. For more complex systems, it is difficult to demonstrate that the measurement data provided by a given sensor configuration, in conjunction with a given model completely describe the dynamics of the system at all times and under all circumstances and that the system does not demonstrate (e.g., chaotic) behavior completely different from the prediction.

### SUMMARY

The present invention provides a method for testing to what extent the dynamics of a technical system starting from a predetermined operation situation are completely described through the acquisition of the state of the technical system with multiple sensors in combination with at least one differential equation. “At least one differential equation” in particular includes the case that there is a system of multiple differential equations that must be satisfied simultaneously. For example, what is described in many places in literature as the Euler-Lagrange equation in the singular is, in fact, a system of partial differential equations. The method presented here works in completely the same way, regardless of whether one or more differential equations are present.

The predetermined operation situation may, for example, in particular be a current operation situation of the technical system, for which it must be ascertained as part of online monitoring of the operation whether the behavior of the technical system is sufficiently predictable or whether the system can demonstrate surprising behavior that deviates from the prediction by the at least one differential equation. However, the predetermined operation situation may, for example, also be a constructed test situation. Before safety-critical technical systems can begin operating, an approval or release is often required, for which the mastery of a plurality of test situations from a specified list must be proven.

According to an example embodiment of the present invention, as part of the method, a dynamics function is established that describes the predetermined operation situation as well as the dynamics of the technical system. This dynamics function depends on measured values from the sensors and/or on quantities derived from these measured values. The dynamics function may, for example, in particular include individual contributions from entities that actively contribute to the dynamics of the technical system, so that its complexity depends on the number of these entities. For example, in a traffic situation as a technical system, each vehicle involved can actively contribute to the dynamics and can therefore be represented with a single contribution in the dynamics function. The complexity of the dynamics function furthermore depends on the number and the level of detail of the measured values as well as the processing of these measured values into the quantities finally included in the dynamics function.

The dynamics function may thus depend heavily on the particular operation situation. For example, a road crossing or a roundabout is describable with a much simpler dynamics function during off-peak periods, when only two vehicles are driven there, than in the peak periods with a plurality of vehicles and different intentions for respective onward travel.

Furthermore, initial conditions, boundary conditions and/or regional conditions for solving the at least one differential equation are ascertained on the basis of the predetermined operation situation. Initial conditions may be given, for example, by initial positions and/or velocities of road users or other entities that contribute to the dynamics of the technical system. Boundary conditions and regional conditions may be predetermined, for example, by roadway profiles or other constraints of the technical system. Any other prior knowledge about the technical system may also be introduced into initial conditions, boundary conditions, regional conditions, or also linking of the dynamics of different entities. For example, the German road traffic regulations mandate that a vehicle that is being passed must not increase its velocity or that, out of town, trucks must travel at least at a distance from one another that allows a passing vehicle to merge.

The at least one differential equation is formed from the dynamics function. For example, a predetermined formula that is based on one or more derivatives of the dynamics function may be used.

It is now tested whether the at least one differential equation is analytically solvable under the previously ascertained initial conditions, boundary conditions and/or regional conditions. If this is the case, it is determined that the acquisition with the sensors and the at least one differential equation completely describe the dynamics of the system. On the other hand, if the at least one differential equation is not analytically solvable, it is determined that the acquisition with the sensors and the at least one differential equation do not completely describe the dynamics of the system. Analytical solvability implies a basic order that controls the dynamics of the technical system and is comparable to the long-range order that controls the spatial arrangement of atoms in a single crystal. The arrangement of all atoms in the single crystal is thus completely described by the arrangement in a single elementary cell, which is constantly repeated. A lack of analytical solvability corresponds in this analogy to a defect in the single crystal, which deviates from the long-range order. Thus, in the phase space, there may be an uncontrollable “hole,” in which the technical system suddenly behaves very differently than predicted by the at least one differential equation.

No mathematical proof is necessary for this test. Rather, a predetermined, automatically executable solution scheme may, for example, be used to search for an analytical solution. If this search is successful, it is proven that there is an analytical solution and that the acquisition with the sensors and the at least one differential equation thus completely describe the dynamics of the system. If this search is unsuccessful, it is not yet mathematically proven that an analytical solution does not exist at all. However, from a safety point of view for the operation of the technical system, a “false negative” classification of the technical system as “not completely described” is significantly less disadvantageous than a “false positive” classification as “completely described.” In the context of the method proposed here, an unsuccessful automated search, implemented in any manner, for an analytical solution is therefore sufficient to determine that the at least one differential equation is not analytically solvable.

With the method proposed here according to the present invention, the dependence of the behavior of the technical system on the operation situation can in particular be tested quickly and efficiently. In this way, physical testing may, for example, be saved in the release process for technical systems and corresponding controls. For example, for systems for at least partially automated driving, it is often necessary to prove controllability for about 100,000 predetermined test situations. For example, if the method proposed here indicates non-controllability for a test situation, it is possible without any further physical tests to directly deduce that something must be improved in the system.

In a particularly advantageous embodiment of the present invention, a Lagrange function L=T−V containing a kinetic energy T and a potential energy V of each entity actively contributing to the dynamics of the technical system is selected as the dynamics function. In this case, the dynamics function can be adapted particularly simply to a varying number of entities, for example vehicles in a traffic situation.

The kinetic energy of an entity depends quadratically on the velocity of this entity, and the potential energy of an entity depends on a height of this entity in the gravitational field of the Earth. For example, the velocity is constantly measured on board a vehicle. The height can be ascertained on the basis of a localization of the vehicle, for example by means of a satellite-based navigation system. For example, the navigation system may directly provide the height. However, the height may, for example, also be ascertained from a digital height model of the Earth, for example from NASA's Global Digital Elevation Model (GDEM) obtained from satellite observations of the Earth, on the basis of the position of the vehicle. Both the kinetic energy and the potential energy also contain the mass of the entity in each case. For the decision to be made in the context of the method proposed here as to whether the at least one differential equation is solvable, a rough estimate of the mass, for example based on the type of road user (such as a passenger vehicle, truck or pedestrian), is sufficient.

A Euler-Lagrange equation in coordinates of the state space as a system of partial differential equations can be formed particularly advantageously from derivatives of the Lagrange function. The solutions of the Euler-Lagrange equation are stationary points of an action functional.

For example, if a technical system has n degrees of freedom, generalized coordinates q₁, . . . , qₙ can be assigned to them. The kinetic energy T can in this case be written in the quadratic form

$$T = \frac{1}{2} {\sum }_{i , j = 1}^{n} {a}_{i , j} ( {q}_{1} , … , {q}_{n} ) {\dot{q}}_{i} {\dot{q}}_{j}$$

with coefficients a_{i,j} depending on the overall state (q₁, . . . , qₙ). For example, for vehicles, if there are N possible driving directions \vec{r}ᵢ which can be expressed via

$${\vec{r}}_{i} = \vec{r} ( {q}_{1} , … , {q}_{n} )$$

by the generalized coordinates q₁, . . . , qₙ, the kinetic energy T can be written as

$$T = {\sum }_{i = 1}^{N} \frac{{m}_{i}}{2} {( {\sum }_{j = 1}^{n} \frac{\partial {\vec{r}}_{i}}{\partial {q}_{j}} {\dot{q}}_{j} )}^{2} = {\sum }_{i = 1}^{N} \frac{{m}_{i}}{2} {\sum }_{j = 1 , k = 1}^{n} \frac{\partial {\vec{r}}_{i}}{\partial {q}_{j}} \frac{\partial {\vec{r}}_{i}}{\partial {q}_{k}} {\dot{q}}_{j} {\dot{q}}_{k} .$$

Here, the order of the summations can be commuted. The kinetic energy T thus becomes

$$T = \frac{1}{2} {\sum }_{j = 1 , k = 1}^{n} ( {\sum }_{i = 1}^{N} {m}_{i} \frac{\partial {\vec{r}}_{i}}{\partial {q}_{j}} \frac{\partial {\vec{r}}_{i}}{\partial {q}_{k}} ) {\dot{q}}_{j} {\dot{q}}_{k} = \frac{1}{2} {\sum }_{j = 1 , k = 1}^{n} {a}_{j , k} {\dot{q}}_{j} {\dot{q}}_{k} .$$

For each degree of freedom m, this results in a component of the Euler-Lagrange equation:

$$\frac{\partial L}{\partial {r}_{m}} - \frac{d}{dt} ( \frac{\partial L}{\partial {\dot{r}}_{m}} ) = 0 .$$

In a particularly advantageous embodiment of the present invention, the test as to whether the at least one differential equation is analytically solvable comprises
retrieving one or more parameterized solution approaches for the at least one differential equation from a predetermined library,
ascertaining one or more equations in the parameters of the solution approach by applying this solution approach to the at least one differential equation, and
testing whether these one or more equations are solvable.

Currently, only a manageable number of different solution approaches that can be tested quickly and automatically is known for differential equations. Many of these solution approaches lead to (for example, linear) equation systems for the parameters, for which it can be quickly determined whether or not they are solvable.

In a further, particularly advantageous embodiment of the present invention, in response to the determination that the acquisition with the sensors and the at least one differential equation do not completely describe the dynamics of the system, the method is performed again, starting from an extended and/or qualitatively improved configuration of sensors; and/or an extended and/or more detailed processing of the measured values from the sensors into quantities on which the dynamics function depends.

In this way, it can be tested whether the deficiency of the incomplete description can be eliminated by changing the configuration of sensors or by changing the processing.

The background in this respect is that any description of the technical system with one or more differential equations and measured values acquired by sensors is based on modeling the technical system. In the context of this modeling, a transition to the domain of numerical mathematics does not necessarily take place, but the modeling can be purely analytical. In this case, the mere act of modeling does not imply digitalization and discretization. The level of detail of these models is chosen such that the phenomena relevant to the operation of the technical system are captured while the model can be calculated simultaneously with predetermined hardware resources in a predetermined time. For example, for the rough description of the movement of planets, the modeling of the Earth as a point mass is sufficient. For planning a flight to the moon, the Earth must already be modeled as a solid ball. In order to describe the dynamics of satellites accurately, this is also no longer sufficient because both the topography of the Earth's surface and the inhomogeneous mass distribution have an effect in this case.

For example, while a vehicle is driving, traffic situations with greatly different complexities may occur. For monitoring and controlling highway driving in good weather and without direct oncoming traffic, two cameras may suffice as sensors. On the other hand, if bad weather prevails at the destination and the vehicle has to merge into a roundabout at a major intersection at rush hour, the situation may only be controllable by the addition of further cameras, radar sensors and/or lidar sensors. Alternatively or in combination thereto, it may, for example, become necessary to process the sensor data with a machine learning model in order to classify other road users and their intentions.

The test as to which configuration of sensors and/or which processing of the measured values is at least necessary for controlling situations is advantageous in two respects. On the one hand, it is thereby possible to ascertain in advance, during the design of vehicles or vehicle systems, what is required as the minimum equipment in terms of hardware in order to successfully control a specified list of test situations. On the other hand, only as much hardware as is actually needed can remain activated during operation. For example, radar sensors or lidar sensors consume additional energy that is only available to a limited extent on board a vehicle. Laser sources or mechanical laser scanners for a lidar system may, for example, also have a limited service life in terms of hours of operation.

In response to the fact that, when the method is performed again, it is determined that the dynamics of the system are now completely described, the extended and/or qualitatively improved configuration of sensors, or the extended and/or more detailed processing of the measured values, is thus advantageously activated or kept activated.

In a further advantageous embodiment of the present invention, the extended and/or more detailed processing of the measured values of the sensors is performed with an additional computing unit and/or on an additional compute instance in a cloud. The fact that the extended and/or more detailed processing does not have to be constantly active, but only if a specific traffic situation, for example, requires it, has a particularly positive effect here. The use of the cloud is usually charged according to a pay-per-use model, and an activated additional computing unit increases energy consumption.

For example, in response to the determination that the acquisition with the sensors and the at least one differential equation do not completely describe the system, the technical system may also be limited in its functionality, put into a safe state or deactivated. For example, the velocity of a vehicle driving in an at least partially automated manner may be reduced, or passing maneuvers may be prevented. The vehicle may, for example, also be brought to a stop on a preplanned emergency stop trajectory. An operator, such as a driver, may, for example, also be prompted to take control of the system.

On the other hand, if it has been determined that the acquisition with the sensors and the at least one differential equation completely describe the dynamics of the system, the method may be performed again, starting from
a reduced and/or qualitatively limited configuration of sensors; and/or
a reduced and/or less detailed processing of the measured values of the sensors into quantities on which the dynamics function depends.

In this way, it can be determined whether a complete description of the system is also possible with less effort.

In particular, in response to the fact that, when the method is performed again, it is determined that the dynamics of the system are still completely described, the operated configuration of sensors may be reduced and/or qualitatively limited, or the further processing of measured values of the sensors may be reduced and/or performed in less detail. As explained above, this can conserve energy and save hours of operation of the components. Optionally, there may be a waiting period between the determination and the reduction or limitation of the sensor configuration and/or the processing in order to avoid the configuration change taking place too quickly.

As explained above, a vehicle and/or a traffic situation with a plurality of road users is particularly advantageously selected as a technical system. Especially in these applications, it is particularly helpful to be able to ascertain the describability and/or controllability for a large number of operation situations in advance as part of a release process and/or in online control during operation. For example, in Euler-Lagrange formalism, a contribution to the kinetic energy T and a contribution to the potential energy V can be attributed to each road user. Furthermore, all road users are linked to a system as a whole by initial conditions, boundary conditions, regional conditions, or other constraints. For example, a line of vehicles that stops at a red traffic light and starts moving again after the traffic light turns green does not behave like a collection of individual vehicles, but rather like a collective. This can be expressed solely by the constraints; detection is not required.

Especially traffic situations can quickly develop during operation from normal situations to critical situations, in which a previously used simple model may no longer be valid. Especially when used in vehicles, the hardware resources for a test for complete description are limited. The method proposed here can make do with computing operations that can also be performed quickly on an embedded system with little computing capacity and memory. The method is therefore advantageously performed in real time on an embedded system that is contained in or carried along by the technical system.

The method may in particular be fully or partly computer-implemented. The present invention therefore also relates to a computer program with machine-readable instructions, which, when they are executed on one or more computers, cause the computer(s) to perform the described method of the present invention. In this sense, control devices for vehicles, virtual machines, compute instances, and other execution environments in the cloud as well as embedded systems for technical devices that are likewise capable of executing machine-readable instructions are also to be regarded as computers.

Likewise, the present invention also relates to a machine-readable data carrier and/or to a download product with the computer program. A download product is a digital product that can be transmitted via a data network, i.e., can be downloaded by a user of the data network, and can, for example, be offered for sale in an online shop for immediate download.

One or more computers can furthermore be equipped with the computer program, with the machine-readable data carrier, or with the download product.

Further measures improving the present invention are described in more detail below with reference to the figures, together with the description of the preferred embodiment examples of the present invention.

### BRIEF DESCRIPTION OF THE DRAWINGS

FIG. 1 shows an embodiment example of the method 100, according to the present invention.

FIG. 2 shows an illustration of the effect of the method 100 on two exemplary traffic situations 20a and 20b, according to an example embodiment of the present invention.

### DETAILED DESCRIPTION OF EXAMPLE EMBODIMENTS

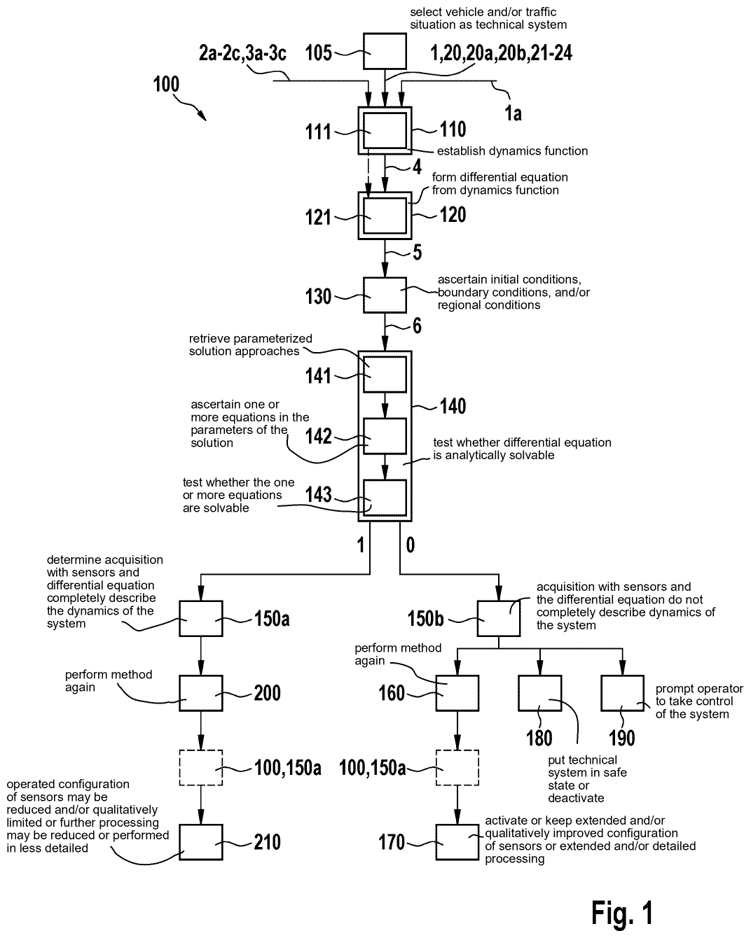

FIG. 1 is a schematic flowchart of an embodiment example of the method 100 for testing to what extent the dynamics of a technical system 1 starting from a predetermined operation situation 1a are completely described through the acquisition of the state of the technical system 1 with multiple sensors 2a-2c in combination with at least one differential equation 5.

According to block 105, a vehicle 21-24, for example, and/or a traffic situation 20, 20a, 20b with multiple road users 21-24 can in particular be selected as a technical system 1.

In step 110, a dynamics function 4, which describes the predetermined operation situation 1a as well as the dynamics of the technical system 1, is established.

In step 120, the at least one differential equation 5 is formed from the dynamics function 4.

According to block 111, a Lagrange function containing a kinetic energy and a potential energy of each entity actively contributing to the dynamics of the technical system can, for example, in particular be selected as the dynamics function 4. According to block 121, a Euler-Lagrange equation in coordinates of the state space of the technical system 1 as a system of partial differential equations 5 can in this case be formed from derivatives of the Lagrange function.

In step 130, initial conditions, boundary conditions and/or regional conditions 6 for solving the at least one differential equation 5 are ascertained on the basis of the predetermined operation situation 1a.

In step 140, it is tested whether the at least one differential equation 5 is analytically solvable. If this is the case (truth value 1), it is determined in step 150a that the acquisition with the sensors 2a-2c and the at least one differential equation 5 completely describe the dynamics of the system 1. Otherwise (truth value 0), it is determined in step 150b that the acquisition with the sensors 2a-2c and the at least one differential equation 5 do not completely describe the dynamics of the system 1.

This test may, for example, in particular comprise
retrieving, according to block 141, one or more parameterized solution approaches for the at least one differential equation 5 from a predetermined library,
ascertaining one or more equations in the parameters of the solution approach by applying, according to block 142, this solution approach to the at least one differential equation 5, and
testing, according to block 143, whether these one or more equations are solvable.

In step 160, in response to the determination 150b that the acquisition with the sensors 2a-2c and the at least one differential equation 5 do not completely describe the dynamics of the system 1, the method 100 may be performed again, starting from an extended and/or qualitatively improved configuration of sensors 2a-2c, and/or an extended and/or more detailed processing of the measured values 3a-3c of the sensors 2a-2c into quantities on which the dynamics function 4 depends.

If it is then found that the dynamics of the system 1 are completely described, the extended and/or qualitatively improved configuration of sensors 2a-2c, or the extended and/or more detailed processing of the measured values 3a-3c, may be activated or kept activated in step 170.

Alternatively or in combination thereto,
the technical system 1 may be limited in its functionality, put into a safe state or deactivated in step 180, and/or
an operator may be prompted in step 190 to take control of the system 1.

In step 200, in response to the determination 150a that the acquisition with the sensors 2a-2c and the at least one differential equation 5 completely describe the dynamics of the system 1, the method may be performed again, starting from
a reduced and/or qualitatively limited configuration of sensors 2a-2c, and/or
a reduced and/or less detailed processing of the measured values 3a-3c of the sensors 2a-2c into quantities on which the dynamics function 4 depends.

In this case, if it is found that the dynamics of the system 1 are still completely described, the operated configuration of sensors 2a-2c may be reduced and/or qualitatively limited, or the further processing of measured values 3a-3c of the sensors 2a-2c may be reduced and/or performed in less detail in step 210. As explained above, this saves energy and hours of operation for components.

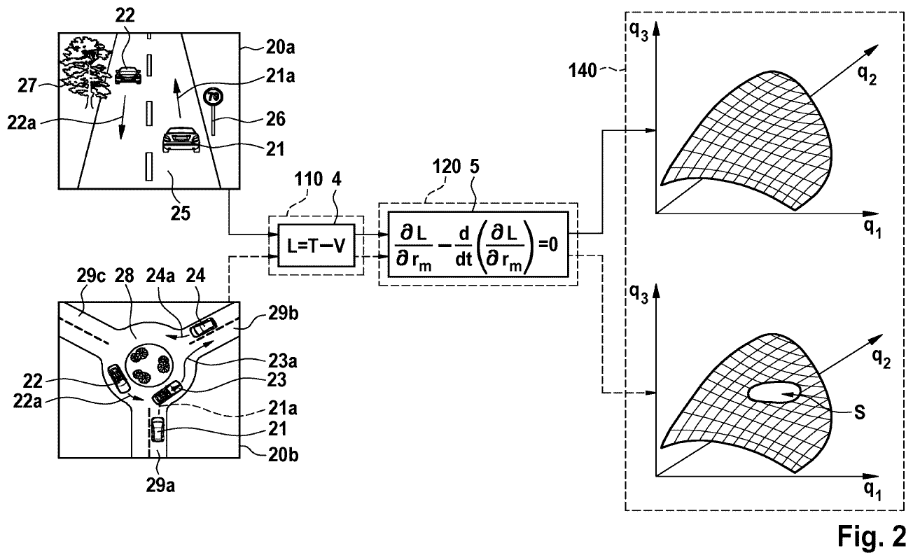

FIG. 2 illustrates the effect of the method 100 on the basis of the example of two traffic situations 20a and 20b. In step 110 of the method 100, a dynamics function 4 is established for both traffic situations 20a and 20b, here a Lagrange function L, which is ascertained according to L=T−V from a kinetic energy T and a potential energy V. From this dynamics function 4, the at least one differential equation 5 is ascertained in step 120, here a Euler-Lagrange equation, which is a system of partial differential equations.

It is subsequently tested in step 140 whether the at least one differential equation 5 is analytically solvable. This is illustrated in each case with a three-dimensional detail of the phase space, which is spanned by three generalized variables q₁, 92 and 93.

The first traffic situation 20a is a simple traffic situation. On a two-lane road 25, two vehicles 21 and 22 driving in opposite directions 21a and 22a approach one another, each on the right lane in their driving direction 21a, 22a. In addition, in the perspective of FIG. 2, a traffic sign 26 is on the right side of the road and a tree 27 is on the left side of the road. In order to describe the dynamics of this traffic situation 20a, a comparatively simple configuration of sensors 2a-2c and not very complex processing of the respective measured values 3a-3c are sufficient. The detail of the phase space that is obtained on this basis nevertheless shows a continuous dependence of the generalized variable q₃ on the other two generalized variables q₁ and q₂, as is to be expected for an analytical solution of the at least one differential equation 5.

The second traffic situation 20b is significantly more complex. It is a roundabout 28 with three entrances 29a-29c. Two vehicles 22 and 23 are already traveling in directions 22a and 23a in the roundabout 28. A third vehicle 24 is about to enter the roundabout 28 from the entrance 29b in the direction 24a. A fourth vehicle 21 intends to enter the roundabout 28 from the entrance 21 in the direction 21a but must first let the vehicles 23 and 22, which have the right of way, pass. If this complex traffic situation 20b is analyzed with the same sensor configuration and processing that was still sufficient for the first, simple traffic situation 20a, a singularity S in the form of a hole results in the detail from the phase space. This singularity S cannot be part of an analytical solution of the at least one differential equation 5. The at least one differential equation 5 thus does not have an analytical solution because the dynamics function 4 from which it originated does not contain enough information.

The example of the roundabout 28 illustrates that the analytical solvability of the at least one differential equation 5 is also critically dependent on initial conditions and regional conditions. For example, with lower occupancy with vehicles 21-24, which all have sufficient distance to one another, there are definitely simpler traffic situations that can be completely analyzed with a simpler sensor configuration and simpler processing.

1-15. (canceled)

16. A method for testing to what extent dynamics of a technical system starting from a predetermined operation situation are completely described through an acquisition of a state of the technical system with multiple sensors in combination with at least one differential equation, comprising the following steps:
establishing a dynamics function describing the predetermined operation situation and the dynamics of the technical system, wherein the dynamics function depends on measured values of the sensors and/or quantities derived from the measured values;
forming the at least one differential equation from the dynamics function;
ascertaining initial conditions and/or boundary conditions and/or regional conditions based on the predetermined operation situation for solving the at least one differential equation;
testing whether the differential equation is analytically solvable under the ascertained initial conditions and/or boundary conditions and/or regional conditions; and
in response to the at least one differential equation being analytically solvable, determining that the acquisition with the sensors and the at least one differential equation completely describe the dynamics of the system.

17. The method according to claim 16, wherein a Lagrange function containing a kinetic energy and a potential energy of each entity actively contributing to the dynamics of the technical system is selected as the dynamics function.

18. The method according to claim 17, wherein a Euler-Lagrange equation in coordinates of a state space of the technical system as a system of partial differential equations is formed from derivatives of the Lagrange function.

19. The method according to claim 16, wherein the test as to whether the at least one differential equation is analytically solvable includes:
retrieving one or more parameterized solution approaches for the at least one differential equation from a predetermined library;
ascertaining one or more equations in the parameters of the solution approach by applying this solution approach to the at least one differential equation; and
testing whether the one or more equations are solvable.

20. The method according to claim 16, wherein, in response to a determination that the acquisition with the sensors and the at least one differential equation do not completely describe the dynamics of the system, the method is performed again, starting from:
extended and/or qualitatively improved configuration of sensors, and/or
an extended and/or more detailed processing of the measured values of the sensors into quantities on which the dynamics function depends.

21. The method according to claim 20, wherein, when the method is performed again, in response to it being determined that the dynamics of the system are now completely described, the extended and/or qualitatively improved configuration of sensors, or the extended and/or more detailed processing of the measured values, is activated or kept activated.

22. The method according to claim 20, wherein the extended and/or more detailed processing of the measured values of the sensors is performed with an additional computing unit and/or on an additional compute instance in a cloud.

23. The method according to claim 16, wherein, in response to a determination that the acquisition with the sensors and the at least one differential equation do not completely describe the dynamics of the system:
(i) the technical system is limited in its functionality or put into a safe state or deactivated; and/or
(ii) an operator is prompted to take control of the system.

24. The method according to claim 16, wherein, in response to a determination that the acquisition with the sensors and the at least one differential equation completely describe the dynamics of the system, the method is performed again, starting from:
(i) a reduced and/or qualitatively limited configuration of sensors, and/or
(ii) a reduced and/or less detailed processing of the measured values of the sensors into quantities on which the dynamics function depends.

25. The method according to claim 24, wherein, when the method is performed again, and, in response to it being determined that the dynamics of the system are still completely described, the operated configuration of sensors is reduced and/or qualitatively limited, or the further processing of measured values of the sensors is reduced and/or performed in less detail.

26. The method according to claim 16, wherein the technical system is a vehicle and/or a traffic situation with multiple road users.

27. The method according to claim 16, wherein the method is performed in real time on an embedded system that is contained in or carried along by the technical system.

28. A non-transitory machine-readable data carrier on which is stored a computer program for testing to what extent dynamics of a technical system starting from a predetermined operation situation are completely described through an acquisition of a state of the technical system with multiple sensors in combination with at least one differential equation, the computer program, when executed by one or more computers, causing the one or more computers to perform the following steps:
establishing a dynamics function describing the predetermined operation situation and the dynamics of the technical system, wherein the dynamics function depends on measured values of the sensors and/or quantities derived from the measured values;
forming the at least one differential equation from the dynamics function;
ascertaining initial conditions and/or boundary conditions and/or regional conditions based on the predetermined operation situation for solving the at least one differential equation;
testing whether the differential equation is analytically solvable under the ascertained initial conditions and/or boundary conditions and/or regional conditions; and
in response to the at least one differential equation being analytically solvable, determining that the acquisition with the sensors and the at least one differential equation completely describe the dynamics of the system.

29. One or more computers equipped with a non-transitory machine-readable data carrier on which is stored a computer program for testing to what extent dynamics of a technical system starting from a predetermined operation situation are completely described through an acquisition of a state of the technical system with multiple sensors in combination with at least one differential equation, the computer program, when executed by the one or more computers, causing the one or more computers to perform the following steps:
establishing a dynamics function describing the predetermined operation situation and the dynamics of the technical system, wherein the dynamics function depends on measured values of the sensors and/or quantities derived from the measured values;
forming the at least one differential equation from the dynamics function;
ascertaining initial conditions and/or boundary conditions and/or regional conditions based on the predetermined operation situation for solving the at least one differential equation;
testing whether the differential equation is analytically solvable under the ascertained initial conditions and/or boundary conditions and/or regional conditions; and
in response to the at least one differential equation being analytically solvable, determining that the acquisition with the sensors and the at least one differential equation completely describe the dynamics of the system.
